(19) United States
(12) Patent Application Publication
(10) Pub. No.: US 2004/0186645 A1
(43) Pub. Date: Sep. 23, 2004

(54) Control apparatus and method for friction device of vehicle

(75) Inventors: Tetsuya Kohno, Okazaki-shi (JP); Yuji Yasuda, Nishikamo-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toyota Jidosha Kabushiki Kaisha, Toyota-shi (JP)

(21) Appl. No.: 10/795,320

(22) Filed: Mar. 9, 2004

(30) Foreign Application Priority Data
Mar. 17, 2003 (JP) 2003-072718

(51) Int. Cl. G06F 17/00; B60T 7/12

(52) U.S. Cl. 701/51; 701/87

(57) ABSTRACT

A control apparatus for a friction device of a vehicle that is disposed in a power transmission path of the vehicle and is adapted to be engaged upon a start of the vehicle is provided. The control apparatus controls the engagement pressure of the friction device so as to eliminate a pulsation component contained in variations in an engagement torque of the friction device.

### INCORPORATION BY REFERENCE

The disclosure of Japanese Patent Application No. 2003-072718 filed on Mar. 17, 2003, including the specification, drawings and abstract, is incorporated herein by reference in its entirety.

### BACKGROUND OF THE INVENTION

1. Field of the Invention

The invention generally relates to an apparatus and a method for controlling a friction device provided in a vehicle and used for starting the vehicle, and, more particularly, to a technique for suppressing or preventing occurrence of vibrations due to stick slip of a friction material of the friction device.

2. Description of Related Art

Generally, a transmission provided in a power transmission path of a vehicle includes a plurality of friction devices, such as hydraulic clutches and brakes, and establishes a selected one of gear stages or speeds by selectively engaging the friction devices. Various control apparatuses for controlling the engaging states of such friction devices have been proposed. For example, a control device for an automatic transmission as disclosed in JP-A-2002-21997 is able to suppress or reduce variations in the output torque during shifting, by changing torque transmitted to the friction devices depending upon the driving conditions of the engine and torque variations due to deterioration of the friction material.

In the meantime, it is known that, when a friction device provided in a power transmission path for starting the vehicle is engaged upon a start of the vehicle, vibrations called “judder” are likely to occur due to stick slip (or intermittent slip) caused by misalignment or material characteristics of friction members of the friction device. While the vibrations, which make the driver uncomfortable, are desired to eliminate, it has been difficult for conventional control apparatuses for vehicular friction devices to suppress or prevent occurrence of the vibrations.

### SUMMARY OF THE INVENTION

It is therefore an object of the invention to provide control apparatus and method for a friction device of a vehicle, which suppress occurrence of vibrations at the time of a start of the vehicle.

To accomplish the above and/or other object(s), there is provided according to one aspect of the invention a control apparatus for controlling an engagement pressure of a friction device of a vehicle that is disposed in a power transmission path of the vehicle and is adapted to be engaged when the vehicle is started, comprising a controller that controls the engagement pressure of the friction device so as to eliminate a pulsation component contained in variations in an engagement torque of the friction device.

The control apparatus as described above controls the engagement pressure of the friction device disposed in the power transmission path of the vehicle and adapted to be engaged upon a start of the vehicle so as to eliminate a pulsation component contained in variations in the engagement torque of the friction device. Thus, the control apparatus is able to settle or converge the pulsation component caused by stick slip of the friction material by, for example, increasing or reducing a squeeze load applied to the friction device, thereby preventing occurrence of judder. Consequently, the control apparatus is able to suppress occurrence of vibrations when the vehicle is started.

In a preferred embodiment of the invention, the control apparatus includes (a) an input rotational speed variation calculating unit that calculates variations in an input rotational speed of a transmission provided in the power transmission path, (b) a pulsation component calculating unit that calculates a pulsation component contained in the variations in the input rotational speed calculated by the input rotational speed variation calculating unit, and (c) an engagement pressure control unit that controls the engagement pressure of the friction device so as to eliminate the pulsation component calculated by the pulsation component calculating unit. Thus, a practical control apparatus for a vehicular friction device can be provided which is simply constructed to monitor variations in the input rotational speed of the transmission corresponding to variations in the engagement torque of the friction device.

In another preferred embodiment of the invention, the control apparatus includes (a) an input torque variation calculating unit that calculates variations in an input torque of a transmission provided in the power transmission path, (b) a pulsation component calculating unit that calculates a pulsation component contained in the variations in the input torque calculated by the input torque variation calculating unit, and (c) an engagement pressure control unit that controls the engagement pressure of the friction device so as to eliminate the pulsation component calculated by the pulsation component calculating unit. Thus, a practical control apparatus for a vehicular friction device can be provided which is simply constructed to monitor variations in the input torque of the transmission corresponding to variations in the engagement torque of the friction device.

In a further preferred embodiment, the engagement pressure control unit calculates a squeeze load containing a pulsation component having a phase opposite to that of the pulsation component calculated by the pulsation component calculating unit, and controls the engagement pressure of the friction device based on the calculated squeeze load. With this arrangement, the control apparatus is able to cancel the pulsation component caused by to stick slip of the friction material of the starting friction device, through control of the squeeze load, and is thus able to efficiently suppress occurrence of vibrations upon a star of the vehicle.

### BRIEF DESCRIPTION OF THE DRAWINGS

The foregoing and/or further objects, features and advantages of the invention will become more apparent from the following description of exemplary embodiments with reference to the accompanying drawings, in which like numerals are used to represent like elements and wherein:

FIG. 1 is a schematic view showing one example of a power transmitting system of a FF (front engine front drive) vehicle, to which the present invention is applied;

FIG. 2 is a table explaining the relationship between a plurality of gear stages of an automatic transmission provided in the vehicle of FIG. 1, and combinations of the operating states of hydraulic friction devices for establishing the respective gear stages;

FIG. 3 is a view schematically showing a part of a hydraulic control circuit for controlling driving of the power transmitting system of FIG. 1, which part is arranged to control a squeeze load of a clutch for starting;

FIG. 4 is a block diagram explaining a control system provided in the vehicle for controlling the engine and automatic transmission of FIG. 1;

FIG. 5 is a functional block diagram explaining the principal control functions of an electronic control unit for transmission as shown in FIG. 4;

FIG. 6 is a time chart explaining one example of starting clutch engagement pressure control performed by the electronic control unit for transmission as shown in FIG. 5;

FIG. 7 is a flowchart explaining a principal part of a starting clutch engagement pressure control routine executed by the electronic control unit for transmission as shown in FIG. 5; and

FIG. 8 is a flowchart explaining a principal part of another starting clutch engagement pressure control routine executed by the electronic control unit for transmission as shown in FIG. 5.

### DETAILED DESCRIPTION OF EXEMPLARY EMBODIMENTS

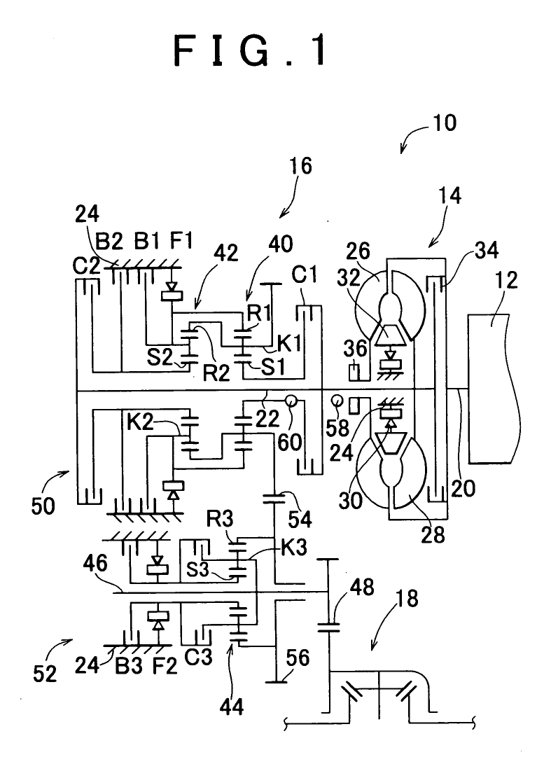

An exemplary embodiment of the invention will be described in detail with reference to the drawings. FIG. 1 schematically shows one example of a power transmitting system 10 of a FF (front engine front drive) vehicle, which employs a control apparatus according to one embodiment of the invention. In the power transmitting system 10, driving force or power generated by an engine 12 as a power source is transmitted to driving wheels (front wheels) (not shown), via a torque converter 14, an automatic transmission 16, and a differential gear unit 18. The torque converter 14 includes a pump impeller 26 coupled to a crankshaft 20 of the engine 12, a turbine wheel 28 coupled to an input shaft 22 of the automatic transmission 16, a stator 32 fixed to a housing 24 as a stationary member via a one-way clutch 30, and a lock-up clutch 34 that directly connects the crankshaft 20 with the input shaft 22. The lock-up clutch 34 is a hydraulic friction device, which is frictionally engaged when a difference in the hydraulic pressure arises between an oil chamber to which the hydraulic pressure is applied to engage the clutch 34 and an oil chamber to which the hydraulic pressure is applied to release the clutch 34. A mechanical oil pump 36, such as a gear pump, is connected to the pump impeller 26, and is driven by the engine 12 to generate the hydraulic pressure for, e.g., shifting or lubrication.

The automatic transmission 16 includes single-pinion type first and second planetary gear sets 40, 42 disposed coaxially with the input shaft 22, a third planetary gear set 44 disposed coaxially with a counter shaft 46 that extends in parallel with the input shaft 22, and an output gear 48 that is fixed to an axial end of the counter shaft 46 and engages with a ring gear of the differential gear unit 18. The first and second planetary gear sets 40, 42 provide a so-called CR-CR coupling type planetary gear mechanism in which a carrier and a ring gear of the first planetary gear set 40 are coupled to a ring gear and a carrier of the second planetary gear set 42, respectively, as described later. Each of the first, second and third planetary gear sets 40, 42, 44 includes a sun gear, a ring gear, a planetary gear that meshes with the sun gear and the ring gear, and a carrier that rotatably supports the planetary gear. The sun gears, ring gears, planetary gears and the carriers of these planetary gear sets 40, 42, 44 are selectively coupled to each other, or selectively coupled to the input shaft 22 via three clutches C1, C2 and C3, or selectively coupled to the housing 24 as a stationary member via three brakes B1, B2 and B3. The automatic transmission 16 further includes two one-way clutches F1, F2 that serve to inhibit rotation of selected components of the planetary gear sets 40, 42, 44 in one direction relative to the housing 24 It is to be noted that the differential gear unit 18 is constructed symmetrically with respect to the axis (axle), and therefore the lower half of the differential gear unit 18 is not illustrated in FIG. 1.

The first planetary gear set 40, second planetary gear set 42, clutches C1 and C2, brakes B1 and B2 and the one-way clutch F1, which are disposed coaxially with the input shaft 22, constitute a primary gear changing portion 50 that provides three forward speeds and one reverse speed. The third planetary gear set 44, clutch C3, brake B3 and the one-way clutch F2, which are disposed coaxially with the counter shaft 46, constitute a secondary gear changing portion 52. The primary gear changing portion 50 is provided with an input rotational speed sensor 58 for detecting the input rotational speed Nin as the speed of rotation of the input shaft 22, and an input torque sensor 60 for detecting the input torque Tin of the automatic transmission 16.

In the primary gear changing portion 50, the input shaft 22 is connected to the sun gear S1 of the first planetary gear set 40 via the clutch C1, and is connected to the sun gear S2 of the second planetary gear set 42 via the clutch C2. The ring gear R1 of the first planetary gear set 40 is coupled to the carrier K2 of the second planetary gear set 42, and the carrier K1 of the first planetary gear set 40 is coupled to the ring gear R2 of the second planetary gear set 42. The ring gear R1 of the first planetary gear set 40 and the carrier K2 of the second planetary gear set 42 are connected to the housing 24 via the brake B1, and the sun gear S2 of the second planetary gear set 42 is connected to the housing 24 via the brake B2. The one-way clutch F1 is disposed between the ring gear R1 and the housing 24. A first counter gear 54 fixed to the carrier K1 of the first planetary gear set 40 engages with a second counter gear 56 fixed to the ring gear R3 of the third planetary gear set 44 so that power is transmitted between the primary gear changing portion 50 and the secondary gear changing portion 52. In the secondary gear changing portion 52, the carrier K3 and sun gear S3 of the third planetary gear set 44 are connected to each other via the clutch C3, and the brake B3 and the one-way clutch F2 are disposed in parallel with each other between the sun gear S3 and the housing 24.

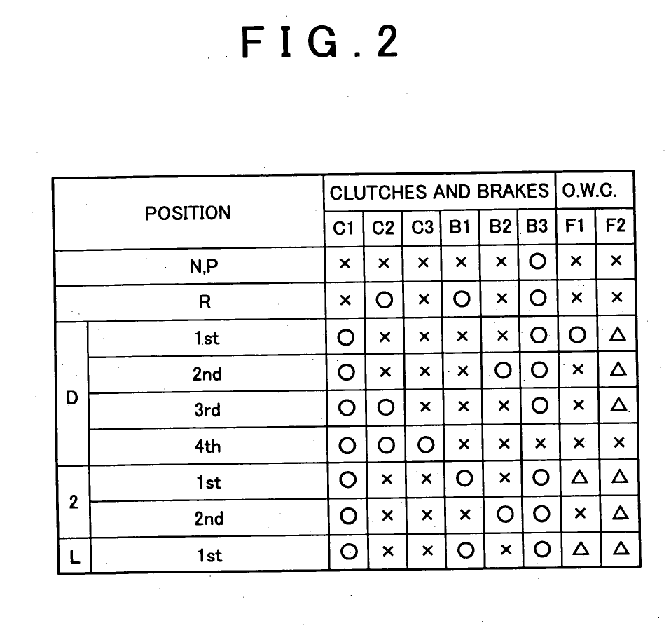

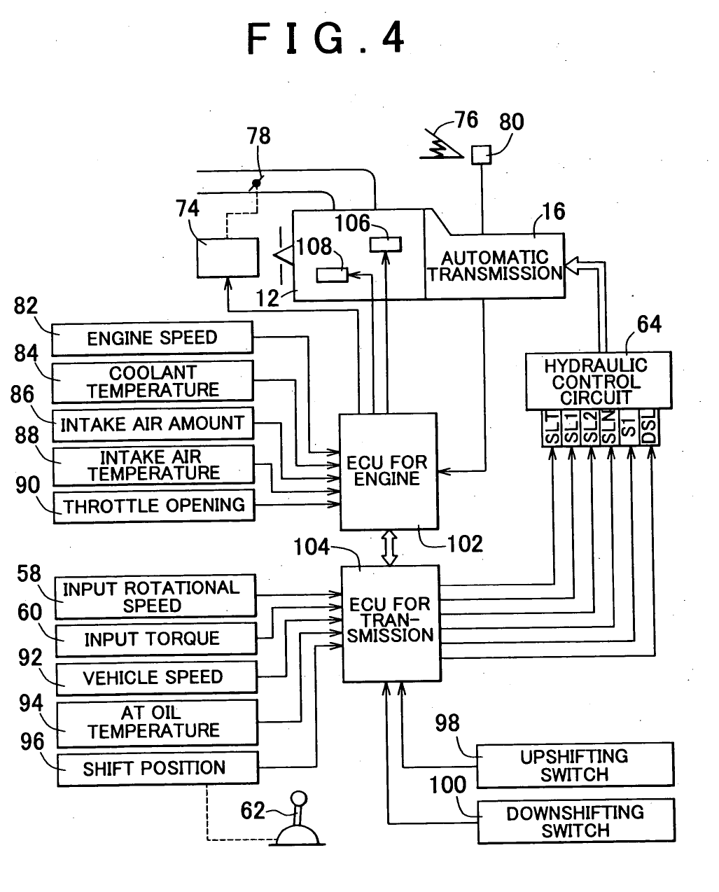

The clutches C1, C2, C3 and the brakes B1, B2, B3 are hydraulic friction devices, such as multiple-disc clutches and brakes, whose engagement pressures are controlled by suitable hydraulic actuators. Each of the clutches C1, C2, C3 and brakes B1, B2, B3 is placed in the engaged or released state, as indicated in the table of FIG. 2, so as to establish a selected one of four forward speed or gear ratios and one reverse speed ratio according to the position to which a shift lever 62 as shown in FIG. 4 is operated. The automatic transmission 16 is shifted from one speed to another speed by switching or changing oil paths by linear solenoid type valves SLT, SL1, SL2, SLN, solenoids S1, DSL, manual valves and the like, thereby changing the engaged/released states of the clutches C1-C3 and brakes B1-B3 as indicated in FIG. 2. In FIG. 2, “1st” through “4th” indicate four forward gear stages having different speed ratios, and “O” and “X” denote the engaged state and released state of each friction device, respectively, while “Δ” denotes the engaged state that involves no power transmission. The shift lever 62 is operated to a selected one of, for example, parking position “P”, reverse-drive position “R”, neutral position “N” and forward-drive positions “D”, “2” and “L”. The automatic transmission 16 is in a neutral condition in which no power transmission occurs when the shift lever 62 is placed in the “P” or “N” position. While no engine brake is applied under the operation of the one-way clutch F1 when the 1st-speed gear stage “1st” of the “D” position is selected, an engine brake is applied through engagement of the brake B1 when the 1st-speed gear stage “1st” of the “2” position or “L” position is selected.

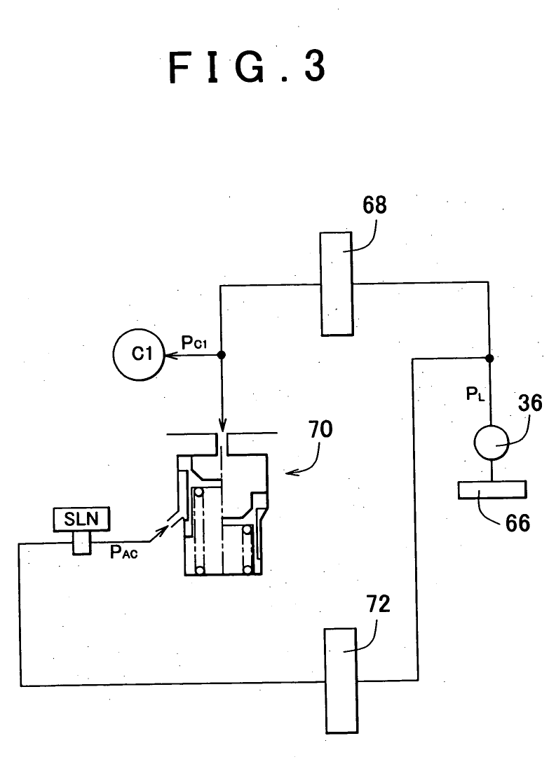

When the vehicle is started, namely, when the automatic transmission 16 is shifted from neutral to the 1st-speed gear stage “1st”, the clutch C1 of the transmission 16 is engaged. Thus, the clutch C1 functions as a starting friction device which is disposed in a power transmission path of the vehicle and is adapted to be engaged upon a start of the vehicle. FIG. 3 schematically shows a part of a hydraulic control circuit 64 for controlling driving of the power transmitting system 10. More specifically, FIG. 3 shows a circuit for controlling the squeeze load of the clutch C1, i.e., the load applied to the clutch C1. Referring to FIG. 3, hydraulic fluid flowing back into an oil tank 66 is fed under pressure by the oil pump 36, and is regulated to a certain line pressure P_{L} by a line-pressure control valve (not shown). The hydraulic fluid is then supplied to the clutch C1 via a manual valve 68 that is mechanically connected with the shift lever 62 and is switched in accordance with the operation of the shift lever 62. The linear solenoid type valve SLN generates pressure P_{AC} proportional to drive current applied thereto, using the line pressure P_{L} supplied via a switching valve 72 as an original pressure. An accumulator 70 operates to generate a controlled pressure by using the pressure P_{AC} as a back pressure so as to control the operating pressure P_{C1} that determines the squeeze load of the clutch C1, according to the back pressure P_{AC}.

FIG. 4 is a block diagram explaining a control system provided in the vehicle for controlling the engine 12 and automatic transmission 16 of FIG. 1, and so forth. An electronic throttle valve 78 is disposed in an intake pipe of the engine 12 shown in FIG. 4. The electronic throttle valve 78 is operated or driven by a throttle actuator 74 such that the opening angle θ_{TH} of the throttle valve 78 basically depends upon the operation amount A_{CC} of an accelerator pedal 76. The control system of FIG. 4 includes an accelerator operation amount sensor 80 for sensing the operation amount A_{CC} of the accelerator pedal 76. The control system further includes an engine speed sensor 82 for measuring the speed N_{E} of revolution of the engine 12, a coolant temperature sensor 84 for measuring the coolant temperature T_{W} of the engine 12, an intake air amount sensor 86 for measuring the intake air amount Q, an intake air temperature sensor 88 for measuring the temperature T_{A} of the intake air, and a throttle sensor 90 equipped with an idle switch. The throttle sensor 90 serves to detect the fully closed state (idling state) of the electronic throttle valve 78 and the opening angle θ_{TH} of the valve 78. The control system further includes a vehicle speed sensor 92 for measuring the vehicle speed V corresponding to the rotational speed (number of revolutions) N_{OUT} of the counter shaft 46, an AT oil temperature sensor 94 for measuring the AT oil temperature T_{OIL} as a temperature of hydraulic fluid in the hydraulic control circuit 64, a lever position sensor 96 for sensing the lever position (operated position) P_{SH} of the shift lever 62, an upshifting switch 98, a downshifting switch 100, and so forth. Signals indicative of the engine speed N_{E}, engine coolant temperature T_{W}, intake air amount Q, intake air temperature T_{A}, throttle opening θ_{TH}, vehicle speed V, AT oil temperature T_{OIL}, lever position P_{SH} of the shift lever 50, upshifting command R_{UP}, downshifting command R_{DN}, input rotational speed Nin and the input torque Tin are supplied from the above-indicated sensors and switches, the input rotational speed sensor 60 and the input torque sensor 62 to an electronic control unit 102 for controlling the engine 12 or an electronic control unit 104 for controlling the automatic transmission 16.

The electronic control unit 102 for engine as shown in FIG. 4 is a so-called microcomputer including CPU, RAM, ROM, input/output interfaces, and so forth. The CPU processes input signals according to programs stored in advance in the ROM, utilizing the temporary storage function of the RAM, and performs various engine controls. For example, the electronic control unit 102 controls a fuel injector 106 for control of the fuel injection quantity, controls an ignitor 108 for control of the ignition timing, and controls the electronic throttle valve 78 through the throttle actuator 74 for traction control. Also, the electronic control unit 102 for engine is connected with the electronic control unit 104 for transmission for mutual communications, such that signals requested by one of the electronic control units 102, 104 are transmitted as needed from the other control unit. The electronic control unit 104 for transmission is a microcomputer similar to the electronic control unit 102 for engine, and the CPU of the control unit 104 processes input signals according to programs stored in advance in the ROM, utilizing the temporary storage function of the RAM. For example, the electronic control unit 104 controls driving of the linear solenoid type valves SLT, SL1, SL2, SLN and solenoids S1, DSL in the hydraulic control circuit 64.

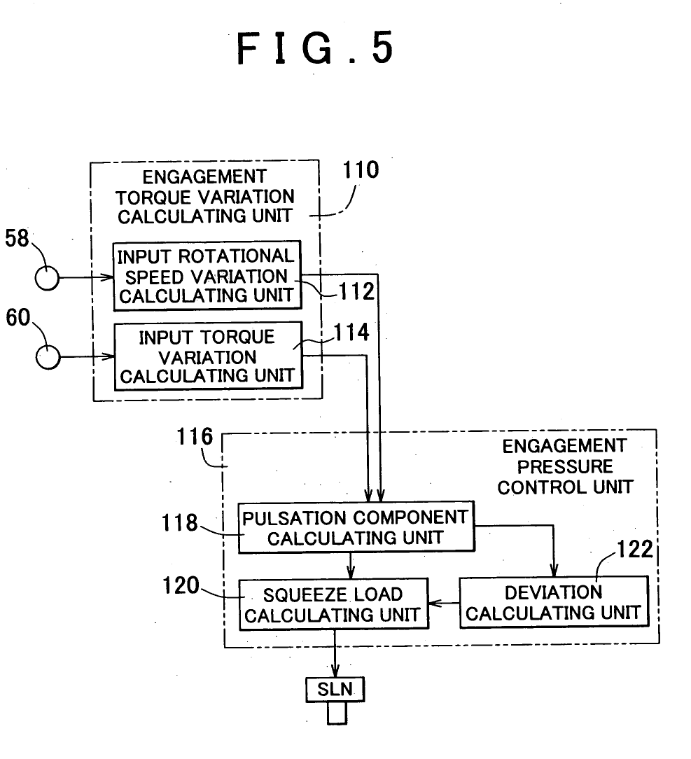

FIG. 5 is a functional block diagram explaining the principal control functions of the electronic control unit 104 for transmission. An engagement torque variation calculating unit 110 shown in FIG. 5 includes an input rotational speed variation calculating unit 112 and an input torque variation calculating unit 114, and calculates variations in the engagement torque of the clutch C1 as the starting friction device. The engagement torque has a one-to-one relationship with the engagement pressure of the clutch C1, and is also called “clutch torque”. The input rotational speed variation calculating unit 112 calculates variations in the input rotational speed Nin, from a signal indicative of the input rotational speed Nin supplied from the input rotational speed sensor 58. The input torque variation calculating unit 114 calculates variations in the input torque Tin, from a signal indicative of the input torque Tin supplied from the input torque sensor 60. The engagement torque of the clutch C1 has a correlation with the input rotational speed Nin or the input torque Tin when the vehicle is started, and therefore the engagement torque of the clutch C1 can be substantially calculated by calculating variations in the input rotational speed Nin or the input torque Tin. While the engagement torque variation calculating unit 110 shown in FIG. 5 includes both the input rotational speed variation calculating unit 112 and the input torque variation calculating unit 114, the engagement torque variation calculating unit 110 may include only one of the calculating units 112, 114.

An engagement pressure control unit 116 includes a pulsation component calculating unit 118, a squeeze load calculating unit 120 and a deviation calculating unit 122, and controls the engagement pressure of the clutch C1 as the starting friction device so as to eliminate a pulsation component contained in variations in the engagement torque of the clutch C1. The engagement pressure, which is also called “clutch pressure”, is a pressure that determines the engaging condition of adjacent friction materials (clutch discs), which condition is determined by the squeeze load, or the like, proportional to the control pressure P_{C1}. More specifically, suitable drive current is fed to the above-indicated linear solenoid type valve SLN in the hydraulic control circuit shown in FIG. 3 so as to generate a suitable squeeze load in the clutch C1.

pulsation component calculating unit 118 calculates a pulsation component g(ωt) contained in the variations in the engagement torque calculated by the engagement torque variation calculating unit 110. More specifically, the pulsation component calculating unit 118 calculates a pulsation component g′(ωt) contained in the variations in the input rotational speed Nin calculated by the input rotational speed variation calculating unit 112, or calculates a pulsation component g″(ωt) contained in the variations in the input torque Tin calculated by the input torque variation calculating unit 114. The squeeze load calculating unit 120 calculates a squeeze load containing a pulsation component g(ωt+π) having a phase opposite to that of the pulsation component g(ωt) calculated by the pulsation component calculating unit 118. More specifically, the squeeze load calculating unit 120 calculates a squeeze load containing a pulsation component g′(ωt+π) having a phase opposite to that of the pulsation component g′(ωt) contained in the variations in the input rotational speed Nin, or calculates a squeeze load containing a pulsation component g″(ωt+π) having a phase opposite to that of the pulsation component g″(ωt) contained in the variations in the input torque Tin.

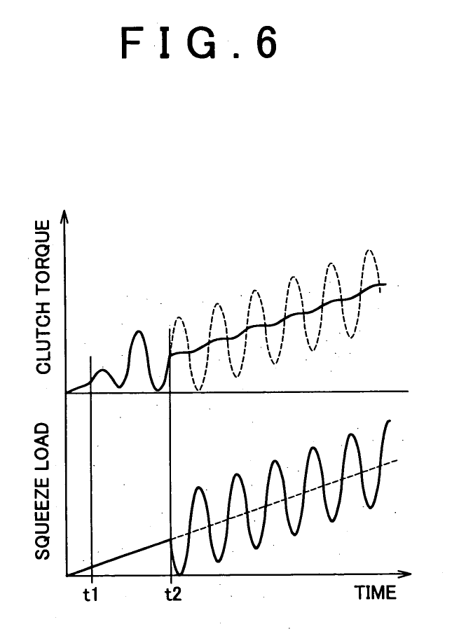

FIG. 6 is a time chart explaining one example of starting clutch engagement pressure control performed by the electronic control unit 104 for transmission. Although the clutch torque (engagement torque) is ideally or desirably changed according to a linear function when the clutch C1 is engaged upon a start of the vehicle, the clutch torque actually pulsates as indicated by a broken line in FIG. 6 in the case where clutch judder occurs due to stick slip of the friction material. Generally, the pulsation has a wave-like property, and the time function CT(t) that represents variations in the clutch torque during occurrence of judder may be expressed by the mathematical expression (1) below, where f(t)=K₁t represents an ideal linear function according to which the clutch torque is desired to change, and g(ωt)=K₂ sin ωt represents a pulsation component contained in the variations in the clutch torque. On the other hand, the squeeze load determined by the operating pressure P_{C1} generated in the hydraulic control circuit of FIG. 3 as described above is normally changed according to a linear function as indicated by a broken line in FIG. 6 so as to change the clutch torque according to a linear function. For example, the squeeze load Cf(t)=C₁t that gives ideal values f(t)=K₁t of the clutch torque as indicated above is generated. Here, the pulsation component calculating unit 118 calculates a pulsation component g(ωt) contained in the variations in the clutch torque, based on, for example, the pattern of pulsation of the clutch torque observed over a period from time t₁ to time t₂ shown in FIG. 6. The squeeze load calculating unit 120 then calculates a squeeze load containing a pulsation component g(ωt+π) having the same frequency and the opposite phase with respect to the pulsation component g(ωt). The time function PL(t) that represents variations in the squeeze load may be expressed by the following mathematical expression (2) below, where Cg(ωt+π)=C₂ sin(ωt+π) represents a squeeze load that cancels the pulsation component g(ωt)=K₂ sin(ωt+π) of the clutch torque. The squeeze load of the expression (2) is applied to the clutch C1 upon and after time t₂ shown in FIG. 6, as indicated by a solid line in FIG. 6, so as to eliminate the pulsation component g(ωt) contained in the variations in the clutch torque CT(t), and realize variations in the clutch torque as indicated by a solid line in FIG. 6 that is close to the ideal linear function f(t).

CT(t)=f(t)+g(ωt)=K₁t+K₂ sin ωt (1)

PL(t)=C{f(t)+g(ωt+π)}=C₁t+C₂ sin(ωt+π) (2)

The deviation calculating unit 122 calculates a deviation Δf(t) from the ideal linear function f(t) with respect to the variations in the engagement torque of the clutch C1 whose engagement pressure is controlled according to the squeeze load calculated by the squeeze load calculating unit 120. More specifically, the deviation calculating unit 122 calculates a deviation Δf(t) from the ideal linear function f(t) with respect to the variations in the input rotational speed Nin, or calculates a deviation Δf′(t) from the ideal linear function f′(t) with respect to the variations in the input torque Tin. The engagement pressure control unit 116 then controls the engagement torque of the clutch C1 in a feedback fashion so as to eliminate the deviation Δf(t). For example, the engagement torque of the clutch C1 is feedback-controlled by increasing or reducing coefficient C₂ in the pulsation component Cg(ω+π)=C₂ sin(ωt+π) of the squeeze load as described above.

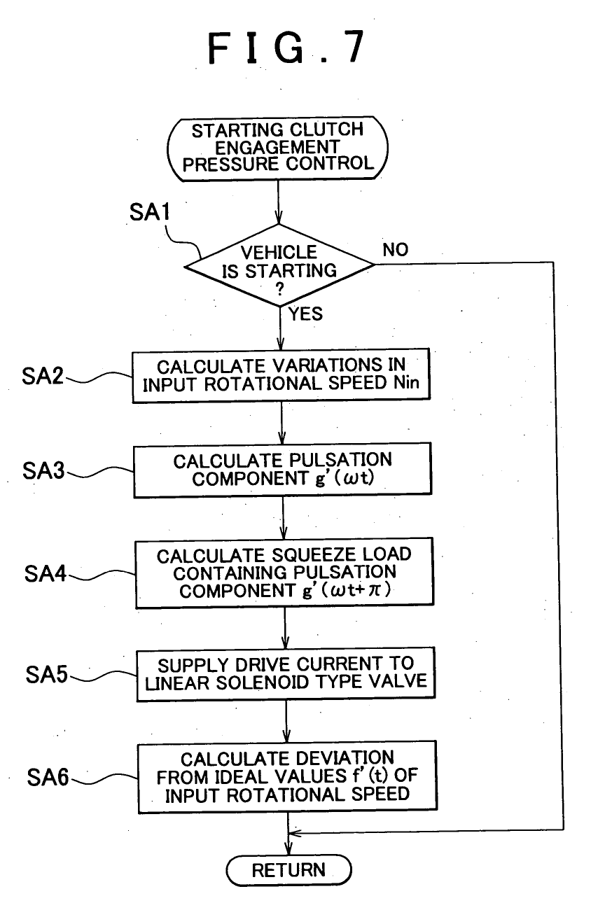

FIG. 7 is a flowchart explaining a principal part of a starting clutch engagement pressure control routine executed by the electronic control unit 104 for transmission. The control routine of FIG. 7 is repeatedly executed at certain time intervals. Initially, it is determined in step SA1 whether the vehicle is being started, namely, whether the automatic transmission 16 is being shifted from neutral to the 1st-speed gear stage “1st”. If a negative determination is made in step SA1, the present routine is finished. If an affirmative determination is made in step SA1, variations in the input rotational speed Nin of the automatic transmission 16 are calculated in step SA2 corresponding to the input rotational speed variation calculating unit 112. The variations in the input rotational speed Nin correspond to variations in the engagement torque of the clutch C1. Subsequently, a pulsation component g′(ωt) contained in the variations in the input rotational speed Nin calculated in step SA2 is calculated in step SA3 corresponding to the pulsation component calculating unit 118. The pulsation component g′(ωt) corresponds to a pulsation component g(ωt) contained in the variations in the engagement torque of the clutch C1. Subsequently, a squeeze load containing a pulsation component g′(ωt+π) having the opposite phase to the pulsation component g′(ωt) calculated in step SA3 is calculated in step SA4 corresponding to the squeeze load calculating unit 120. In the following step SA5, suitable drive current is supplied to the linear solenoid type valve SLN so that the hydraulic control circuit shown in FIG. 3 produces the squeeze load calculated in step SA4. In step SA6 corresponding to the deviation calculating unit 122, a deviation Δf(t) from the ideal linear function f(t) of the input rotational speed corresponding to the ideal linear function f(t) of the engagement torque of the clutch C1, which deviation is involved in the variations in the input rotational speed Nin, is calculated, and the present routine is then finished. In step SA4 of the next control cycle, the squeeze load is calculated in view of the deviation Δf(t) of the input rotational speed calculated in step SA6 of the previous cycle. For example, the amplitude of the pulsation component, or the like, is increased or reduced in step SA4 so that the deviation Δf(t) is eliminated. The above-indicated step SA2 corresponds to the engagement torque variation calculating unit 110, and steps SA3 through SA6 correspond to the engagement pressure control unit 116.

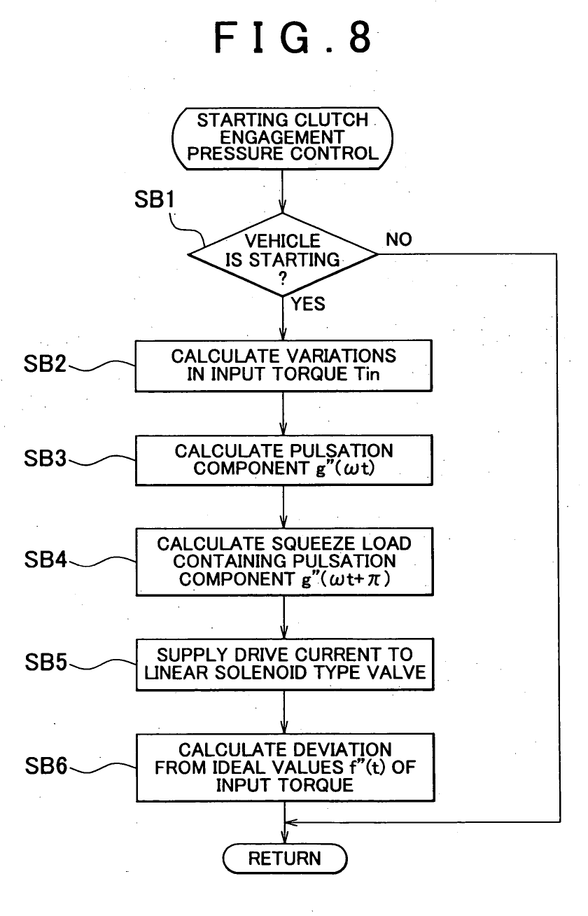

FIG. 8 is a flowchart explaining a principal part of another starting clutch engagement pressure control routine executed by the electronic control unit 104 for transmission. The control routine of FIG. 8 is repeatedly executed at certain time intervals. Initially, it is determined in step SB1 whether the vehicle is being started, namely, whether the automatic transmission 16 is being shifted from neutral to the 1st-speed gear stage “1st”. If a negative determination is made in step SB1, the present routine is finished. If an affirmative determination is made in step SB1, variations in the input torque Tin of the automatic transmission 16 are calculated in step SB2 corresponding to the input torque variation calculating unit 114. The variations in the input torque Tin correspond to variations in the engagement torque of the clutch C1. Subsequently, a pulsation component g″(ωt) contained in the variations in the input torque Tin calculated in step SB2 is calculated in step SB3 corresponding to the pulsation component calculating unit 118. The pulsation component g″(ωt) corresponds to a pulsation component g(ωt) contained in the variations in the engagement torque of the clutch C1. Subsequently, a squeeze load containing a pulsation component g″(ωt+π) having the opposite phase to the pulsation component g″(ωt) calculated in step SB3 is calculated in step SB4 corresponding to the squeeze load calculating unit 120. In the following step SB5, suitable drive current is supplied to the linear solenoid type valve SLN so that the hydraulic control circuit shown in FIG. 3 produces the squeeze load calculated in step SB4. In step SB6 corresponding to the deviation calculating unit 122, a deviation Δf′(t) from the ideal linear function f′(t) of the input torque corresponding to the ideal linear function f(t) of the engagement torque of the clutch C1, which deviation is involved in the variations in the input torque Tin, is calculated, and the present routine is then finished. In step SB4 of the next control cycle, the squeeze load is calculated in view of the deviation Δf′(t) of the input torque calculated in step SB6 of the previous cycle. For example, the amplitude of the pulsation component, or the like, is increased or reduced in step SB4 so that the deviation Δf′(t) is eliminated. The above-indicated step SB2 corresponds to the engagement torque variation calculating unit 110, and steps SB3 through SB6 correspond to the engagement pressure control unit 116.

As described above, the control apparatus according to the present embodiment controls the engagement pressure of the clutch C1 as a friction device that is disposed in the power transmission path of the vehicle and is adapted to be engaged upon a start of the vehicle, so as to eliminate the pulsation component g(ωt) contained in variations in the engagement torque of the clutch C1. Thus, the control apparatus of the present embodiment is able to settle or converge the pulsation component g(ωt) caused by stick slip of the friction material by, for example, increasing or reducing the squeeze load of the clutch C1, and is thus able to prevent occurrence of judder. Thus, the control apparatus for the friction device of the vehicle is able to suppress or prevent occurrence of vibrations at the time of a start of the vehicle.

The control apparatus of the present embodiment includes the input rotational speed variation calculating unit 112 (SA2) that calculates variations in the input rotational speed Nin of the transmission 16 provided in the power transmission path, the pulsation component calculating unit 118 (SA3) that calculates a pulsation component g′(ωt) contained in the variations in the input rotational speed Nin calculated by the input rotational speed variation calculating unit 112, and the engagement pressure control unit 116 (SA3 through SA6) that controls the engagement pressure of the clutch C1 so as to eliminate the pulsation component g′(ωt) calculated by the pulsation component calculating unit 118. Thus, the present invention provides a practical control apparatus for a friction device of a vehicle, which is simply constructed to monitor variations in the input rotational speed Nin of the transmission 16 corresponding to variations in the engagement torque of the clutch C1.

The control apparatus of the present embodiment includes the input torque variation calculating unit 114 (SB2) that calculates variations in the input torque Tin of the transmission 16 provided in the power transmission path, the pulsation component calculating unit 118 (SB3) that calculates a pulsation component g″(ωt) contained in the variations in the input torque Tin calculated by the input torque variation calculating unit 114, and the engagement pressure control unit 116 (SB3 through SB6) that controls the engagement pressure of the clutch C1 so as to eliminate the pulsation component g″(ωt) calculated by the pulsation component calculating unit 118. Thus, the present invention provides a practical control apparatus for a friction device of a vehicle, which is simply constructed to monitor variations in the input torque Tin of the transmission 16 corresponding to variations in the engagement torque of the clutch C1.

The engagement pressure control unit 116 includes the squeeze load calculating unit 120 (SA4, SB4) that calculates a squeeze load containing a pulsation component g(ωt+π) having the opposite phase to the pulsation component g(ωt) calculated by the pulsation component calculating unit 118, and controls the engagement pressure of the clutch C1 according to the squeeze load calculated by the squeeze load calculating unit 120. Thus, the control apparatus of the present embodiment can cancel or eliminate the pulsation component g(ωt) caused by stick slip of the friction material in the clutch C1, through control of the squeeze load, thereby efficiently suppressing or preventing occurrence of vibrations upon a start of the vehicle.

While one exemplary embodiment of the invention has been described with reference to the drawings, the invention is not limited to details of the illustrated embodiment, but may be otherwise embodied.

In the illustrated embodiment, the friction device that is disposed in the power transmission path of the vehicle and is engaged upon a start of the vehicle is in the form of the hydraulic clutch C1 whose engagement pressure is controlled by hydraulic pressure. However, the invention is not limitedly applied to this type of friction device. For example, the friction device may be in the form of a hydraulic brake, an electromagnetic clutch or brake whose engagement pressure is controlled by electromagnetic force, a clutch using electromagnetic powder, or the like, provided that such a clutch or brake functions as a friction device. Where the starting friction device is of an electromagnetic type, the engagement pressure control unit 116 directly controls the starting friction device electrically.

In the illustrated embodiment, the operating pressure P_{C1} that determines the squeeze load of the clutch C1 is regulated by the accumulator 70, which uses the pressure P_{AC} generated by the linear solenoid type valve SLN as a back pressure. However, the operating pressure P_{C1} may be directly regulated by a suitable linear solenoid type valve.

In the illustrated embodiment, the engagement pressure control unit 116 calculates a pulsation component g(ωt) contained in variations in the engagement torque of the clutch C1, and then calculates a squeeze load containing a pulsation component g(ωt+π) having the opposite phase to the pulsation component g(ωt), so as to control the engagement pressure of the clutch C1 according to the squeeze load. However, the engagement pressure control unit may carry out simpler or easier control provided that the pulsation component g(ωt) contained in the variations in the engagement torque of the clutch C1 can be eliminated in a suitable manner.

While the clutch C1 as one constituent element of a general automatic transmission (16) is used as a starting friction device in the illustrated embodiment, the invention may also be applied to a clutch for starting provided in, for example, a vehicle equipped with MMT (a multi-mode manual transmission) or SMT (single-mode manual transmission) in a power transmission path. In a vehicle equipped with CVT in a power transmission path, the lock-up pressure may be controlled by the control apparatus of the present invention.

In the illustrated embodiment, the engagement pressure is controlled based on the relationship between one of the input rotational speed Nin and the input torque Tin of the automatic transmission 16 and the engagement torque of the clutch C1. However, variations in both of the input rotational speed Nin and the input torque Tin may be monitored, and the engagement pressure may be controlled based on the relationship between these input rotational speed and input torque Tin, and the engagement torque of the clutch C1. Also, the engagement pressure may be controlled based on the relationship between another parameter that is totally different from the input rotational speed and the input torque, and the engagement torque of the clutch.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

What is claimed is:

1. A control apparatus for controlling an engagement pressure of a friction device of a vehicle that is disposed in a power transmission path of the vehicle and is adapted to be engaged when the vehicle is started, comprising:
a controller that controls the engagement pressure of the friction device so as to eliminate a pulsation component contained in variations in an engagement torque of the friction device.

2. The control apparatus as defined in claim 1, wherein the controller comprises:
an input rotational speed variation calculating unit that calculates variations in an input rotational speed of a transmission provided in the power transmission path;
a pulsation component calculating unit that calculates a pulsation component contained in the variations in the input rotational speed calculated by the input rotational speed variation calculating unit; and
an engagement pressure control unit that controls the engagement pressure of the friction device so as to eliminate the pulsation component calculated by the pulsation component calculating unit.

3. The control apparatus as defined in claim 2, wherein the engagement pressure control unit calculates a squeeze load containing a pulsation component having a phase opposite to that of the pulsation component calculated by the pulsation component calculating unit, and controls the engagement pressure of the friction device based on the calculated squeeze load.

4. The control apparatus as defined in claim 1, wherein the controller comprises:
an input torque variation calculating unit that calculates variations in an input torque of a transmission provided in the power transmission path;
a pulsation component calculating unit that calculates a pulsation component contained in the variations in the input torque calculated by the input torque variation calculating unit; and
an engagement pressure control unit that controls the engagement pressure of the friction device so as to eliminate the pulsation component calculated by the pulsation component calculating unit.

5. The control apparatus as defined in claim 4, wherein the engagement pressure control unit calculates a squeeze load containing a pulsation component having a phase opposite to that of the pulsation component calculated by the pulsation component calculating unit, and controls the engagement pressure of the friction device based on the calculated squeeze load.

6. The control apparatus as defined in claim 1, wherein the controller comprises:
a variation calculating unit that calculates variations in at least one parameter that has a predetermined relationship with the engagement torque of the friction device;
a pulsation component calculating unit that calculates a pulsation component contained in the variations in said at least one parameter calculated by the variation calculating unit; and
an engagement pressure control unit that controls the engagement pressure of the friction device so as to eliminate the pulsation component calculated by the pulsation component calculating unit.

7. The control apparatus as defined in claim 6, wherein said at least one parameter comprises an input rotational speed of a transmission provided in the power transmission path and an input torque of the transmission.

8. The control apparatus as defined in claim 6, wherein the engagement pressure control unit calculates a squeeze load containing a pulsation component having a phase opposite to that of the pulsation component calculated by the pulsation component calculating unit, and controls the engagement pressure of the friction device based on the calculated squeeze load.

9. The control apparatus as defined in claim 1, wherein the friction device is a hydraulic clutch whose engagement pressure is controlled by a hydraulic pressure.

10. A method for controlling an engagement pressure of a friction device of a vehicle that is disposed in a power transmission path of the vehicle and is adapted to be engaged when the vehicle is started, wherein:
the engagement pressure of the friction device is controlled so as to eliminate a pulsation component contained in variations in an engagement torque of the friction device.

11. The method as defined in claim 10, comprising the steps of:
calculating variations in an input rotational speed of a transmission provided in the power transmission path;
calculating a pulsation component contained in the variations in the input rotational speed; and
controlling the engagement pressure of the friction device so as to eliminate the calculated pulsation component.

12. The method as defined in claim 11, wherein the step of controlling the engagement pressure comprises calculating a squeeze load containing a pulsation component having a phase opposite to that of the calculated pulsation component, and controlling the engagement pressure of the friction device based on the calculated squeeze load.

13. The method as defined in claim 10, comprising the steps of calculating variations in an input torque of a transmission provided in the power transmission path;
calculating a pulsation component contained in the variations in the input torque; and
controlling the engagement pressure of the friction device so as to eliminate the calculated pulsation component.

14. The method as defined in claim 13, wherein the step of controlling the engagement pressure comprises calculating a squeeze load containing a pulsation component having a phase opposite to that of the calculated pulsation component, and controlling the engagement pressure of the friction device based on the calculated squeeze load.

15. The method as defined in claim 10, comprising the steps of:
calculating variations in at least one parameter that has a predetermined relationship with the engagement torque of the friction device;
calculating a pulsation component contained in the variations in said at least one parameter; and
controlling the engagement pressure of the friction device so as to eliminate the calculated pulsation component.

16. The method as defined in claim 15, wherein said at least one parameter comprises an input rotational speed of a transmission provided in the power transmission path and an input torque of the transmission.

17. The method as defined in claim 15, wherein the step of controlling the engagement pressure comprises calculating a squeeze load containing a pulsation component having a phase opposite to that of the calculated pulsation component, and controlling the engagement pressure of the friction device based on the calculated squeeze load.

18. The method as defined in claim 10, wherein the friction device is a hydraulic clutch whose engagement pressure is controlled by a hydraulic pressure.
